(19) United States
(12) Patent Application Publication
(10) Pub. No.: US 2024/0324079 A1
(43) Pub. Date: Sep. 26, 2024

(54) LINEAR DIMMER FOR LED LIGHTING

(71) Applicant: Hang Jae YU, Seongnam-si (KR)

(72) Inventor: Hang Jae YU, Seongnam-si (KR)

(21) Appl. No.: 18/614,357

(22) Filed: Mar. 22, 2024

(30) Foreign Application Priority Data
Mar. 22, 2023 (KR) 10-2023-0037020

(51) Int. Cl. H05B 45/10; H05B 45/345; H05B 45/37

(52) U.S. Cl. CPC H05B 45/10; H05B 45/345; H05B 45/37

(57) ABSTRACT

The present invention relates to a linear dimmer for an LED lighting, which controls an illumination in an LED lighting apparatus, the linear dimmer including: a rectifier circuit unit full-wave rectifying a commercial alternating current (AC) power supplied from an input stage (AC line), and outputs a rectified current power; and a current control circuit unit connected to an output stage of the rectifier circuit unit, and controlling the rectified current power output by the rectifier circuit unit to a predetermined current magnitude, and outputting the predetermined current power to an LED lighting.

### CROSS-REFERENCE TO RELATED APPLICATION

This application claims under 35 U.S.C. § 119(a) the benefit of Korean Patent Application No. 10-2023-00370202 filed on Mar. 22, 2023, the entire contents of which are incorporated herein by reference.

### BACKGROUND

### (a) Technical Field

The present invention relates to illuminance control technology of an LED lighting, and more particularly, to a linear dimmer for an LED lighting, which controls an illuminance in an LED lighting apparatus.

### (b) Background Art

For an incandescent lamp and a halogen lighting that have been used for past 100 years, a phase-cut mode Triac dimmer has been used. The incandescent lamp and the halogen lighting are modes that heat metal filaments such as tungsten alloys and emit light, and as the filament, the Triac dimmer has been usefully used as a resistive element without a problem for a long time.

The phase-cut mode Triac dimmer used in the conventional incandescent lamp and halogen lighting illustrated in FIG. 7 is a structure in which Triac is turned on/off through Diac by using resistance values of a variable resistance VR1 and a resistance R1, and a capacitance of C1, i.e., an RC time constant.

However, in recent years, an LED lighting apparatus has become one of light sources of a most popular alternative lighting which has improved luminous efficacy and price of a high-brightness LED. In home and commercial lightings, while an LED which is a semiconductor element is used, a switching mode converter or a linear mode converter is used, and the converter is configured by using an active semiconductor element other than a pure resistive passive element, there are problems such as a malfunction such as blinking by electric noise and limitations in dimming range in using the existing phase-cut mode Triac dimmer.

Therefore, digital mode dimming modes such as analog 0-10V, DALI, etc., have been developed and used, but the modes require a separate line or wireless signal path, so the phase-cut mode is still preferred and used which can simply change and install a switch to a dimmer.

Accordingly, LED lighting companies have been trying to improve malfunctions caused by noise and as a result, many of them are being overcome, and the US energy star regulations have also set the dimming range to 20% to 80% to promote the supply of the phase-cut mode.

However, consumers are accustomed to the use of the incandescent lamp or the halogen lighting with a dimming range of a 0% to 100% in the past, making them uncomfortable with the use of the dimmer in the LED lighting. In particular, hospital operating rooms and ophthalmology hospitals require less than 1% of low-illuminance dimming, but it is difficult to find products that satisfy this requirement.

However, the phase-cut mode dimmer that has been widely used has a big drawback in electrical properties. For example, as the brightness of an incandescent lamp of 100 W is controlled from 100% to 0% by using the phase-cut mode dimmer, a power factor is reduced from 99% to 40%. When the dimmer is adjusted to the minimum illuminance with the naked eye, electric power consumed jointly by the dimmer and the incandescent lamp is 17 W.

Similarly, when the LED lighting is used as a phase-cut mode dimmer, as the illuminance is controlled to be low, the power factor is lowered to a low level. Further, the decrease in power factor leads to an increase in harmonics to cause power loss in a transmission line, which may cause a failure of a transformer.

### PRIOR ART DOCUMENT

### Patent Document

(Patent Document 1) Korean Laid-open Utility Model Publication No. 20-1997-0001700 (1997 Mar. 15)

### SUMMARY OF THE DISCLOSURE

The present invention is devised to solve the problem, and it is an object thereof to provide a linear dimmer for an LED lighting, which does not decrease a power factor even in low-illuminance dimming, and at the same time, enables designing of an LED lighting apparatus, which may correspond to noise generated from an AC input wire.

In order to achieve the object, a linear dimmer for an LED lighting according to an exemplary embodiment of the present invention includes: a rectifier circuit unit full-wave rectifying a commercial alternating current (AC) power supplied from an input stage (AC line), and outputting a rectified current power; and a current control circuit unit connected to an output stage of the rectifier circuit unit, and controlling the rectified current power output by the rectifier circuit unit to a predetermined current magnitude, and outputting the predetermined current power to an LED lighting.

The rectifier circuit unit is a bridge rectifier circuit that converts AC into rectified current using four diodes D1, D2, D3, and D4.

The current control circuit unit is a constant current circuit, and the constant current circuit includes one field effect transistor, and a fixed resistance and a variable resistance connecting a gate and a source of the one field effect transistor, and provided between the gate and the source, and controls a magnitude of the variable resistance to control a magnitude of constant current output to the LED lighting.

The fixed resistance is a resistance R1 connected to the source stage of the one field effect transistor, the variable resistance is constituted by a first variable resistance VR1 and a second variable resistance VR2 of which one end is connected to the gate stage of the one field effect transistor and the other end is connected to the resistance R1 in series to form a node, and the constant current circuit further includes a resistance R2 and a constant current source CC1 connected in series between the drain stage and the gate stage of the one field effect transistor.

The fixed resistance includes a first resistance R1 of which one end is connected to the source stage of the one field effect transistor and a second resistance of which one end is connected to the gate stage of the one field effect transistor, and one end of the variable resistance is connected to the other end of the first resistance R1 and the other end is connected to the other end of the second resistance R2 to form a node.

A power factor of the linear dimmer for an LED lighting increases as an illuminance is controlled to be low.

According to the present invention, there is an effect in which a power factor is not lowered even in low-luminance dimming, so there is no minute blinking, and it is possible to cope with noise generated from an AC input wire.

Further, according to the present invention, there is an effect in which power loss in a transmissions line can be reduced by preventing a decrease in power factor. As a result, according to the present invention, a safe LED lighting apparatus can be manufactured.

Further, according to the present invention, there is an effect in which reliability enhancement, failure reduction, and lifespan extension of the LED lighting apparatus are possible through the prevention of the decrease in power factor.

Further, according to the present invention, there is an effect in which a miniaturized product can be manufactured with low cost by implementing a linear dimmer for an LED lighting through a simple circuit design.

### BRIEF DESCRIPTION OF THE DRAWINGS

FIG. 1 is a block diagram schematically illustrating a power supply device of an LED lighting to which a linear dimmer for an LED lighting is applied according to a first exemplary embodiment of the present invention.

FIG. 2 is a block diagram schematically illustrating a power supply device of an LED lighting to which a linear dimmer for an LED lighting is applied according to a second exemplary embodiment of the present invention.

FIG. 3 is a block diagram schematically illustrating a power supply device of an LED lighting to which a linear dimmer for an LED lighting is applied according to a third exemplary embodiment of the present invention.

FIG. 4 is a block diagram schematically illustrating a power supply device of an LED lighting to which a linear dimmer for an LED lighting is applied according to a fourth exemplary embodiment of the present invention.

FIG. 5 is a circuit diagram illustrating a first example of a current control circuit unit illustrated in FIGS. 1 to 4.

FIG. 6 is a circuit diagram illustrating a second example of the current control circuit unit illustrated in FIGS. 1 to 4.

FIG. 7 is a circuit diagram illustrating a phase-cut mode Triac dimmer used in a conventional incandescent light.

### DETAILED DESCRIPTION

Hereinafter, the present invention will be described in detail with reference to the accompanying drawings. In this case, the same components in each drawing are represented by the same reference numerals as much as possible. In addition, detailed descriptions of already known functions and/or configurations are omitted. In contents disclosed below, a description focuses on parts necessary for understanding the operation according to various exemplary embodiments, and descriptions of elements that may obscure the gist of the description are omitted. In addition, some components of the drawings may be exaggerated, omitted, or schematically illustrated. The size of each component does not entirely reflect the actual size, and thus the contents described herein are not limited by the relative size or spacing of the components drawn in the respective drawings.

In describing the exemplary embodiments of the present invention, a detailed description of the known art related with the present invention will be omitted when it is judged that the detailed description may unnecessarily make the gist of the present invention unclear. In addition, the terms to be described below as terms which are defined in consideration of functions in the present invention may vary depending on the intention or usual practice of a user or an operator. Accordingly, the terms need to be defined based on contents throughout this specification. The terms used in a detailed description are to just describe the exemplary embodiments of the present invention and should not be restrictive in any way. Unless specifically used otherwise, expression of a singular form includes a meaning of a plural form. In the present description, an expression such as “including” or “comprising” is intended to indicate certain features, numbers, steps, operations, elements, some or combinations thereof and should not be construed to preclude the presence or possibility of one or more other features, numbers, steps, operations, elements, some or combinations thereof in addition to the described things.

Further, the terms including a first, a second, and the like may be used for describing various components, but the components are not limited by the terms and the terms are used only for distinguishing one component from other components.

Hereinafter, an exemplary embodiment of the present invention will be described in more detail with reference to the accompanying drawings.

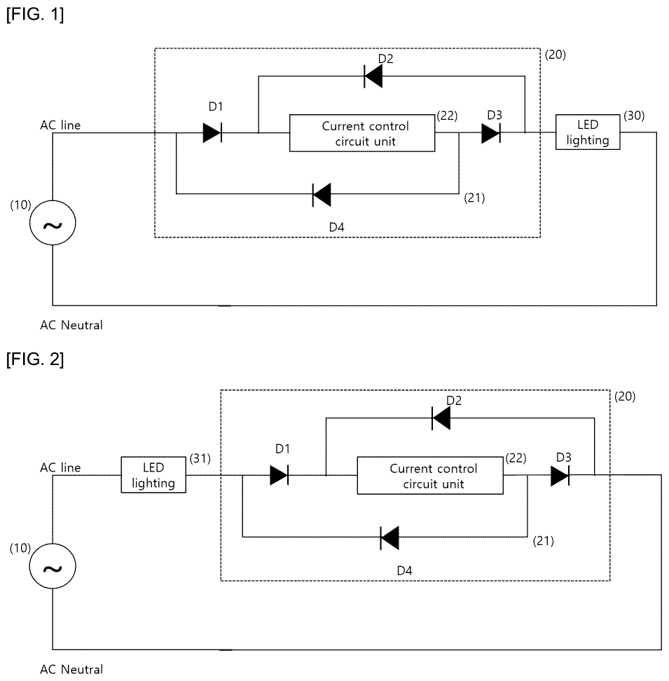

FIG. 1 is a block diagram schematically illustrating a power supply device of an LED lighting to which a linear dimmer for an LED lighting is applied according to an exemplary embodiment of the present invention.

Referring to FIG. 1, the linear dimmer 20 for an LED lighting according to an exemplary embodiment of the present invention is configured to include at least a rectifier circuit unit (D1, D2, D3, and D4) 21, and a current control circuit unit 22.

The rectifier circuit unit (D1, D2, D3, and D4) 21 may be configured as a bridge rectifier circuit, and performs conversion of alternating current into rectified current using a diode.

The rectifier circuit unit (D1, D2, D3, and D4) 21 full-wave rectifies a commercial alternating current (AC) power 10 supplied from an input stage (AC line) of the commercial AC power 10, and outputs a rectified current power.

Meanwhile, although not illustrated, a capacitor which smooths the full-wave rectified direct current (DC) may be connected to an output stage of the rectifier circuit unit (D1, D2, D3, and D4) 21.

In the exemplary embodiment of the present invention, when the current control circuit unit 22 is connected to the output stage of the rectifier circuit unit (D1, D2, D3, and D4) 21, and the current control circuit unit 22 outputs the rectified current power output from the rectifier circuit unit (D1, D2, D3, and D4) 21 to an LED lighting 30 by controlling a current magnitude to a predetermined current range.

In this case, the current control circuit unit 22 may control the current magnitude to control an illuminance of the LED lighting 30 from the maximum to the minimum.

That is, the current control circuit unit 22 controls the magnitude of the current by using a variable resistance in a current limiting circuit.

The current control circuit unit 22 may be configured as a constant current circuit, and the constant current circuit supplies constant current having a predetermined magnitude to the LED lighting 30 regardless of an input voltage or load. The constant current circuit may be implemented so that a gate and a source of one field effect transistor are connected, wherein the gate G and the source S are connected so that one or more fixed resistances and variable resistances are provided between the gate G and the source S of the field effect transistor FET, and a magnitude of the variable resistance is controlled to control a magnitude of the constant current output to the LED lighting 30.

In the present invention, the field effect transistor (FET) is used, but the present invention is not limited thereto, and various types of transistors, e.g., a bipolar junction transistor (BJT), a metal oxide semiconductor field effect transistor (MOSFET), an insulated-gate bipolar transistor (IGBT), a junction field effect transistor (JFET), etc., may be appropriately used according to a desired design.

As such, the linear dimmer 20 for an LED lighting according to an exemplary embodiment of the present invention includes a current control circuit unit that supplies an output having a predetermined magnitude to the LED lighting 30, so that a power factor is not lowered even low-illuminance dimming, and at the same time, it may be possible to design an LED lighting apparatus which may correspond to noise generated from an AC input wire. That is, the linear dimmer for an LED lighting according to the present invention has the effect of reducing power loss in a transmission line by preventing the power factor from being lowered, so a safe LED lighting apparatus can be manufactured.

FIGS. 2 to 4 are block diagrams schematically illustrating power supply devices of an LED lighting to which a linear dimmer for an LED lighting is applied, respectively, according to second to fourth exemplary embodiments of the present invention.

As illustrated in FIG. 2, in a power supply device of an LED lighting to which the linear dimmer for the LED lighting according to the second exemplary embodiment of the present invention is applied, an LED lighting 31 may be positioned at a front stage of the linear dimmer 20 for the LED lighting compared to a configuration in which the LED lighting 30 is positioned at a rear stage of the linear dimmer 20 for the LED lighting in the power supply device according to the first exemplary embodiment illustrated in FIG. 1.

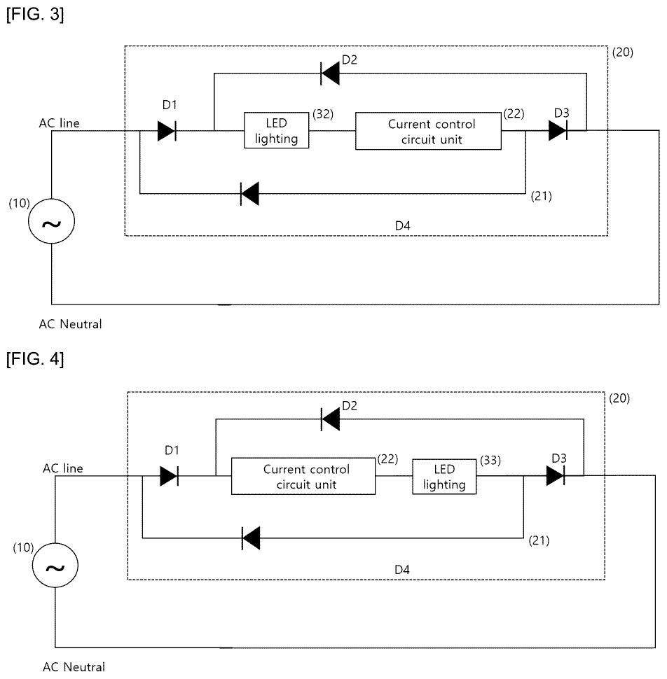

As illustrated in FIG. 3, in the power supply device of the LED lighting to which the linear dimmer for the LED lighting according to the third exemplary embodiment of the present invention is applied, an LED lighting 32 may be positioned at a rear stage of a current control circuit unit 22 in the linear dimmer 20 for the LED lighting.

As illustrated in FIG. 4, in the power supply device of the LED lighting to which the linear dimmer for the LED lighting according to the fourth exemplary embodiment of the present invention is applied, an LED lighting 33 may be positioned at a front stage of the current control circuit unit 22 in the linear dimmer 20 for the LED lighting, i.e., between the rectifier circuit units (D1, D2, D3, and D4) 21 and the current control circuit unit 22.

As such, the linear dimmer for the LED lighting according to the present invention may appropriately place a location of the LED lighting according to a desired structure and design.

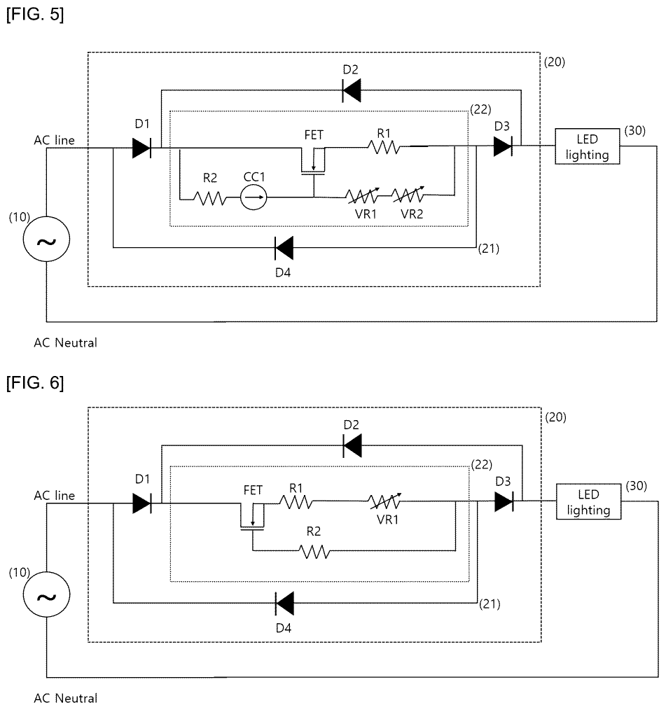

FIG. 5 is a circuit diagram illustrating a first example of a current control circuit unit 22 illustrated in FIGS. 1 to 4. The same component as the linear dimmer for the LED lighting illustrated in FIGS. 1 to 4 is denoted by the same reference numeral, and a detailed description of the same component is omitted.

Referring to FIG. 5, the current control circuit unit 22 according to the first example of the present invention as a current limiting circuit may be implemented to include one field effect transistor and a resistance R1 connected to a source stage of one field effect transistor, and include two variable resistances VR1 and VR2 connected between the source stage and a gate stage of one field effect transistor of which one end is connected to the gate stage and the other end is connected to the resistance R1 in series to form a node, and a resistance R2 and a constant current source CC1 connected in series between the drain stage and the gate stage of one field effect transistor.

Here, the variable resistances VR1 and VR2 as current controlling variable resistances adjust a resistance value of the variable resistance to adjust an output voltage and an output current which flows on the resistance as desired, and when the resistance value increases, the output voltage increases and the output current decreases.

The current control circuit unit 22 controls two variable resistances connected in series between the source stage and the gate stage of one field effect transistor to control a magnitude of an output.

Accordingly, as described above, in the linear dimmer 20 for the LED lighting according to an exemplary embodiment of the present invention, the commercial AC power 10 is converted into the rectified current power through the rectifier circuit unit 21, and the converted rectified current power controls an on/off operation of the field effect transistor FET through the variable resistances VR1+VR2. The variable resistances VR1 and VR2 generate a gate driving voltage V_{GS} which makes the field effect transistor FET be an on state to make the field effect transistor FET be the on state, and accordingly, flowing drain current I_{D} is output to the LED lighting 30 via the resistance R1. Since the drain current I_{D} is changed according to the gate driving voltage V_{GS}, the gate driving voltage V_{GS} is controlled by using the variable resistances VR1 and VR2 to control the magnitude of the output.

Through this, in the linear dimmer for the LED lighting according to the exemplary embodiment of the present invention, the current output to the LED lighting 30 through the current control circuit may be maintained in a predetermined range, and stabilized.

Further, as listed in Table 1 below, by applying the present invention to the LED lighting apparatus, an output current having a relatively high power factor, for example, a power factor of 0.97 to 0.99 may be obtained as being close to a lowest illuminance. Here, the power factor means a ratio at which electric power supplied from a power supply is effectively used in a load.

TABLE 1

| | Triac dimmer mode dimmer | Linear control mode dimmer according |
|---|---|---|
| | in related art | to the present invention |
| 38 W | PF0.87 | PF0.89 |
| 25 W | PF0.69 | |
| 20 W | | PF0.92 |
| 15 W | PF0.55 | |
| 12 W | | PF0.95 |
| 10 W | PF0.47 | PF0.99 |
| 5 W | PF0.39 | |
| 4 W | | PF0.97 |

Comparison in change of the power factor between a dimmer using a Triac dimmer in the related art (FIG. 6) and a linear control mode dimmer according to the present invention.

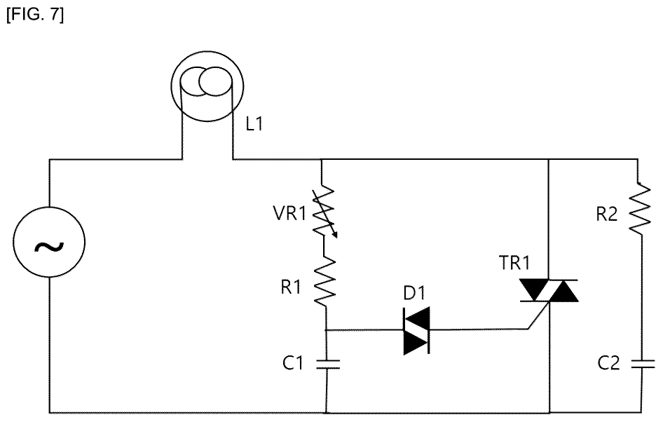

As can be seen in Table 1, in the Triac dimmer mode dimmer in the related art (illustrated in FIG. 7), as the illuminance is controlled to be lower, the power factor is relatively lowered, and decreased to a low level, whereas in the linear control mode dimmer according to the present invention, as the illuminance is controlled to be lower, the power factor is raised, and a high-level power factor may be obtained.

That is, the lowering of the power factor in the related art leads to an increase in harmony, causes the power loss in the transmission loss, which may cause a failure of the transformer, and the present invention may prevent such a phenomenon.

FIG. 6 is a circuit diagram illustrating a second example of the current control circuit unit 22 illustrated in FIGS. 1 to 4. The same component as the linear dimmer for the LED lighting illustrated in FIGS. 1 to 4 is denoted by the same reference numeral, and a detailed description of the same component is omitted.

Referring to FIG. 6, the current control circuit unit 22 according to the second example of the present invention may be implemented to include a variable resistance in the current limiting circuit, and include one field effect transistor, a resistance R1 of which one end is connected to the source stage of one field effect transistor, a variable resistance VR1 of which one end is connected to the other end of the resistance R1, and a resistance R2 of which one end is connected to the gate stage and the other end is connected to the other end of the variable resistance V1 to form a node.

Here, one field effect transistor is a depletion mode FET, and the variable resistance VR1 as a current controlling variable resistance may adjust a resistance value of the variable resistance to adjust an output voltage and an output current which flows on the resistance as desired, and when the resistance value increases, the output voltage increases and the output current decreases.

That is, the current control circuit unit 22 may control the variable resistance VR1 connected in series to the source stage of one field effect transistor to control a magnitude of an output.

The exemplary embodiment of the present invention has been described as above and a fact that the present invention can be embodied in other specific forms without departing from the gist or scope in addition to the above-described exemplary embodiment is apparent to those skilled in the art. Therefore, the aforementioned exemplary embodiment is not limited but should be considered to be illustrative, and accordingly, the present invention is not limited to the above description and may be modified within the scope of the appended claims and a range equivalent thereto.

What is claimed is:

1. A linear dimmer for an LED lighting, comprising:
a rectifier circuit unit full-wave rectifying a commercial alternating current (AC) power supplied from an input stage (AC line), and outputting a rectified current power; and
a current control circuit unit connected to an output stage of the rectifier circuit unit, and controlling the rectified current power output by the rectifier circuit unit to a predetermined current magnitude, and outputting the predetermined current power to an LED lighting.

2. The linear dimmer for an LED lighting of claim 1, wherein the rectifier circuit unit is a bridge rectifier circuit that converts AC into rectified current using four diodes D1, D2, D3, and D4.

3. The linear dimmer for an LED lighting of claim 2, wherein the current control circuit unit is a constant current circuit, and
the constant current circuit includes one field effect transistor, and a fixed resistance and a variable resistance connecting a gate and a source of the one field effect transistor, and provided between the gate and the source, and
controls a magnitude of the variable resistance to control a magnitude of constant current output to the LED lighting.

4. The linear dimmer for an LED lighting of claim 3, wherein the fixed resistance is a resistance R1 connected to the source stage of the one field effect transistor,
the variable resistance is constituted by a first variable resistance VR1 and a second variable resistance VR2 of which one end is connected to the gate stage of the one field effect transistor and the other end is connected to the resistance R1 in series to form a node, and
the constant current circuit further includes a resistance R2 and a constant current source CC1 connected in series between the drain stage and the gate stage of the one field effect transistor.

5. The linear dimmer for an LED lighting of claim 3, wherein the fixed resistance includes a first resistance R1 of which one end is connected to the source stage of the field effect transistor and a second resistance R2 of which one end is connected to the gate stage of the one field effect transistor, and
one end of the variable resistance is connected to the other end of the first resistance R1 and the other end is connected to the other end of the second resistance R2 to form a node.

6. The linear dimmer for an LED lighting of claim 1, wherein a power factor of the linear dimmer for an LED lighting increases as an illuminance is controlled to be low.
